(19) United States
(12) Patent Application Publication
(10) Pub. No.: US 2025/0307945 A1
(43) Pub. Date: Oct. 2, 2025

(54) SYSTEM AND METHOD FOR SETTLING INSURANCE CLAIMS USING ARTIFICIAL INTELLIGENCE

(71) Applicant: MWC FAMILY LP, East Hampton, NY (US)

(72) Inventor: Michael Crow, East Hampton, NY (US)

(21) Appl. No.: 19/098,706

(22) Filed: Apr. 2, 2025

Related U.S. Application Data
(60) Provisional application No. 63/573,114, filed on Apr. 2, 2024.

(51) Int. Cl. G06Q 40/08; G06N 20/00; G06Q 10/10; G16Y 20/10

(52) U.S. Cl. CPC G06Q 40/08; G06N 20/00; G06Q 10/10; G16Y 20/10

(57) ABSTRACT

Provided herein is a system for settling insurance claims. The system includes a computer; one or more remote sensors configured to generate sensor data for at least one dwelling and communicate the sensor data to the computer; and monitoring software configured to run on the server. The sensor data includes a first set of sensor data collected at a first time point and a second set of sensor data collected at a second time point. The monitoring software is configured to process the sensor data; compare the first set of sensor data to the second set of sensor data; and measure damage to the at least one dwelling based upon the comparison of the first set of sensor data to the second set of sensor data. Also provided are a method of settling insurance claims using the system and a non-transitory, processor-readable medium storing instructions for executing the method.

### CROSS-REFERENCE TO RELATED APPLICATIONS

The present application claims priority under 35 U.S.C. § 119 (e) to U.S. Provisional Patent Application No. 63/573,114, filed Apr. 2, 2024, which application is incorporated herein by reference in its entirety.

### FIELD OF THE INVENTION

The present invention relates to a system and method for settling insurance claims using artificial intelligence, and in particular to a system and method that utilizes cameras and artificial intelligence to set insurance payouts based on pre-established parameters.

### BACKGROUND OF THE INVENTION

The concept of parametric insurance is well known. The National Association of Insurance Commissioners (NAIC) has defined parametric insurance as a type of insurance contract that insures a policyholder against the occurrence of a specific event by paying a set amount based on the magnitude of the event. This is as opposed to a traditional indemnity policy, where the amount paid is determined by the magnitude of the losses. An example of a parametric policy is a policy that pays $100,000.00 if there's an earthquake with a magnitude of 5.0 or higher, regardless of the damage incurred. The insurance contract should specify the payment amount, the trigger (e.g., earthquake magnitude), and a third party that checks to see if the trigger happened. Usually, a government agency, like the National Earthquake Information Center, does this. There might be backup verifiers in case the main agency can't do it. For example, if the earthquake damages the sensors of the National Earthquake Information Center so that their issuance of an official magnitude is delayed, another agency's reading may be used so that payment is still timely.

Accordingly, there remains a need in the art for improved systems and methods for settling insurance claims. The present invention meets this need.

### SUMMARY

In one aspect, a system for settling insurance claims includes a computer; one or more remote sensors configured to generate sensor data for at least one dwelling and communicate the sensor data to the computer; and monitoring software configured to run on the server; wherein the sensor data includes a first set of sensor data collected at a first time point and a second set of sensor data collected at a second time point; and wherein the monitoring software is configured to process the sensor data, compare the first set of sensor data to the second set of sensor data, and measure damage to the at least one dwelling based upon the comparison of the first set of sensor data to the second set of sensor data. In some embodiments, the first time point is before a triggering event and the second time point is after the triggering event. In some embodiments, the first set of sensor data includes images of the dwelling before the triggering event and the second set of sensor data includes images of the dwelling after the triggering event. In some embodiments, the one or more remote sensors include a digital camera.

In some embodiments, the system further includes a machine-learning model configured to run on the computer; wherein the machine-learning model is configured to automatically measure the damage to the dwelling caused by the triggering event. In some embodiments, the machine-learning model is an unsupervised machine-learning model, a supervised machine-learning model, a deep learning model, or a convolutional neural network (CNN). In some embodiments, the machine-learning model is configured to detect the triggering event based upon the sensor data. In some embodiments, the machine-learning model is configured to automatically record the second set of sensor data after the triggering event. In some embodiments, the machine-learning model is configured to automatically record images of the dwelling during the triggering event. In some embodiments, the one or more remote sensors include a digital camera and at least one of a water flow sensor, a water leak sensor, a temperature sensor, a motion sensor, a license plate recognition sensor, a smoke detector, a carbon monoxide sensor, a thermal imaging sensor, a barometric sensor, a power line sensor, a current sensor, and combinations thereof. In some embodiments, the one or more sensors are connected through the internet of things (IoT). In some embodiments, the machine-learning model is trained on a training set including at least one of damage photographs and corresponding repair costs, tenant data, property data, claim history for a tenant, property, and combinations thereof.

In some embodiments, the monitoring software is further configured to generate at least one user interface. In some embodiments, one or more of the at least one user interfaces is configured to display claim information for the at least one dwelling following the triggering event.

In another aspect, method of settling insurance claims includes providing the system according to any of the embodiments disclosed herein; receiving, at the server the first set of sensor data and the second set of sensor data; comparing, via the monitoring software, the first set of sensor data to the second set of sensor data; measuring, via the monitoring software, damage to the at least one dwelling based upon the comparison of the first set of sensor data to the second set of sensor data; and calculating a claim payout based upon the measured damage. In some embodiments, the insurance claim comprises a parametric insurance claim. In some embodiments, the method further includes generating at least one user interface.

In some embodiments, the monitoring software comprises a machine-learning model. In some embodiments, the method further includes training the machine-learning model, the training including providing a training set including at least one of damage photographs and corresponding repair costs, tenant data, property data, claim history for a tenant, property, and combinations thereof; and training the machine-learning model on the training set.

In another aspect, a non-transitory, processor-readable medium storing instructions that, when executed by a processor, cause the processor to implement the method according to any of the claims disclosed herein.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows a schematic of a system according to an embodiment of the disclosure.

FIGS. 2A-G show images illustrating various aspects of a user interface according to embodiments of the disclosure. (A) Dashboard showing graphical summary of claims. (B) Listing of various types of claim information. (C) Breakdown of claims filed. (D) Breakdown of claims severity. (E) Breakdown of claims per unit in multi-unit dwelling. (F) Breakdown of incident type. (G) Breakdown of emergency response times.

### DETAILED DESCRIPTION OF THE INVENTION

### Definitions

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

The terms “proximal” and “distal” can refer to the position of a portion of a device relative to the remainder of the device or the opposing end as it appears in the drawing. The proximal end can be used to refer to the end manipulated by the user. The distal end can be used to refer to the end of the device that is inserted and advanced and is furthest away from the user. As will be appreciated by those skilled in the art, the use of proximal and distal could change in another context, e.g., the anatomical context in which proximal and distal use the patient as reference, or where the entry point is distal from the user.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION

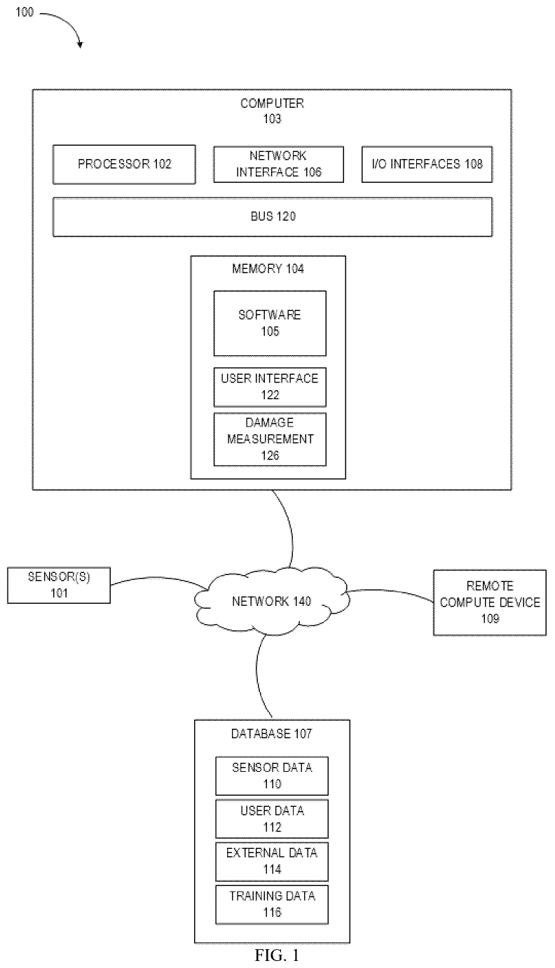

Provided herein are systems for settling insurance claims. The system 100 includes a computer 103, one or more remote sensors 101 configured to communicate sensor data to the computer 103, and monitoring software 105 configured to run on the computer 103 (FIG. 1). In some embodiments, the system 100 is configured to record sensor data from the one or more remote sensors 101, communicate the sensor data from the one or more sensors 101 to the computer 103, and measure objective damage and/or calculate insurance losses based upon the sensor data. In some embodiments, the insurance claims include claims under a parametric model.

The computer 103 includes any suitable computer for receiving the sensor data and running the monitoring software 105. For example, suitable computers 103 include, but are not limited to, a personal computer, a server (e.g., a cloud server or any other suitable server), or any other compute device capable of receiving the sensor data and running the monitoring software 105 on memory 104 thereof. In some embodiments, the system 100 also includes a database 107 coupled to the computer 103, the database 107 configured to receive and store the sensor data.

The one or more remote sensors are positioned at and/or configured to be positioned at any suitable dwelling, such as, but not limited to, a residential dwellings, a multi-unit dwelling, and/or multiple properties including one or more dwellings. Suitable sensors include, but are not limited to, water flow sensors, water leak sensors, water pulse sensors, temperature sensors, humidity sensors, motion sensors, still cameras, video cameras, cameras that detect certain movement and activity, license plate reading/recognition cameras, smoke detectors, carbon monoxide sensors, door open/closed sensors, window open/closed sensors, thermal imaging sensors, barometric sensors, power line sensors, current sensors, and/or combinations thereof. In some embodiments, multiple sensors may be combined into a single device (e.g., combined smoke alarm and CO sensor). In some embodiments, the one or more sensors include at least at least a digital camera or recording device (e.g., video camera and/or still camera). In some such embodiments, the digital cameras or recording device is configured to capture a ‘360’ view of the interior and/or exterior of one or more dwellings. In embodiments where the one or more dwellings include a multi-family dwelling (e.g., apartment complex), the ‘360’ view includes the dwelling as a whole, as well as each individual unit within the dwelling.

The sensors can be connected to each other and/or the computer through any suitable connection mechanism. For example, in some embodiments, the sensors are connected through the internet of things (IoT). Additionally or alternatively, in some embodiments, the sensors operate on the long range (LoRa) frequency band and/or through the LoRaWAN® protocol. LoRa uses license-free sub-gigahertz radio frequency bands, such as 902-928 MHz in North America, and enables long-range transmissions with low power consumption. In some embodiments, the sensors send gathered data (e.g., via LoRa) to a gateway device that is coupled to the computer (e.g., a cloud server). In some embodiments, the sensor data includes multimodal telemetry data. Although discussed herein with respect to IoT and/or LoRa communication, as will be appreciated by those skilled in the art, the disclosure is not so limited and includes any other suitable method of communication such as, but not limited to, Bluetooth, ethernet, satellite, or a combination thereof.

In some embodiments, the sensors can continuously provide sensor data to the system (i.e., 24 hours a day, 7 days a week). For example, in some embodiments, the sensors are configured to continuously provide sensor data up to and through a triggering event. As used herein, the term “triggering event” includes any event that triggers an insurance claim, such as, but not limited to, fire, flood, earthquake, tornado, hurricane, other weather (e.g., wind, hail), or any other event that is covered by an insurance policy. In some embodiments, the continuous monitoring of one or more sensors enables the system to automatically detect the occurrence of a triggering event. In such embodiments, the system can measure objective damage as a result of the triggering event based upon a comparison of the sensor data immediately prior to and after the triggering event. For example, in some embodiments, the system can compare video and/or photographs of the dwelling immediately before and immediately after detection of the triggering event in order to measure objective damage as a result of the triggering event. With continuous monitoring, the system can also compare data from windows leading up to and following the triggering event, enabling more accurate measurement of mitigating factors and/or residual damage following the event.

Additionally or alternatively, in some embodiments, the system is configured to periodically record sensor data from the one or more sensors. For example, in some embodiments, the system is configured to record sensor data relating to a dwelling (e.g., videos, photographs) at set intervals. The set intervals may be any suitable interval depending upon the type of event(s) and/or dwelling(s) covered by the insurance policy. Such intervals may include, but are not limited to, daily, every other day, every three days, every four days, every five days, every six days, weekly, every two weeks, every three weeks, monthly, every other month, quarterly, every six months, yearly, or any suitable combination, sub-combination, range, or sub-range thereof. In some embodiments, the system is also configured to record sensor data (e.g., videos, photographs) ahead of a predicted triggering event, during a detected triggering event, and/or immediately after a triggering event. As will be appreciated by those skilled in the art, triggering events can be predicted based upon sensor data, weather reports, and/or any other suitable information relating to predicted events. Similarly, triggering events can be detected through sensor data, emergency alerts, and/or any other suitable information relating to actual occurrence of the event. In addition, the system can be manually instructed to record sensor data at any time, including, but not limited to, before a predicted triggering event, during a triggering event, and/or after a triggering event.

In some embodiments, the system is configured to monitor one or more sensors continuously and record sensor data from one or more other sensors at set intervals. For example, in some embodiments, the system is configured to record video and/or photographic sensor data at set intervals while continuously monitoring other sensor data. The other sensor data may include data relating to the condition of the dwelling covered by the policy and/or conditions that can be used to predict and/or detect the occurrence of a triggering event. For example, in some embodiments, the system records video and/or photographic sensor data at set intervals while continuously monitoring temperature, humidity, wind speed, seismic activity, smoke detector data, and/or CO monitor data. In addition to predicting and/or detecting the occurrence of a triggering event the other sensor data may be used to determine whether mitigating factors were involved in any resulting damage. For example, the other sensor data can be used to determine if the dwelling was maintained at conditions conducive to mold, if the dwelling was maintained at conditions conducive to pipes freezing, if doors and/or windows were left open during a storm, or any other suitable determination relative to mitigating factors.

Although discussed herein primarily with respect to video and/or photographic evidence in combination with other sensor data, as will be appreciated by those skilled in the art, the disclosure is not so limited and may include any other suitable sensor or combination of sensors being monitored continuously and/or recorded periodically. Additionally, as will also be understood by those skilled in the art, the specific sensor or combination of sensors being monitored/recorded can vary and/or be selected based upon the policy coverage and/or predicted triggering event. For example, in one embodiment, during high fire risk conditions, the system may be configured to monitor temperature and smoke while continuously or more frequently recording video and/or photographic data. In another embodiment, one or more digital cameras or recording devices are configured to capture a ‘360’ view of the interior a multi-family dwelling prior to any insurance events occurring (e.g., continuously, manually, or at set intervals). Thereafter, if a triggering event occurs, another ‘360’ view of the multi-family dwelling is captured. The baseline view (i.e., view prior to the triggering event) is then compared to the post-event view to measure damage and/or calculate payout. Other use cases include, but are not limited to, roof damage from wind and hail, flood damage from interior or exterior flooding.

In some embodiments, the monitoring software automatically compares the sensor data, measures damage, and/or calculates payout. Additionally or alternatively, in some embodiments, the monitoring software utilizes artificial intelligence (AI) to compares the sensor data, measures damage, and/or calculates payout. In some embodiments, the AI includes a machine-learning model trained to compares the sensor data, measures damage, and/or calculates payout. For example, in some embodiments, the monitoring software and/or machine-learning model is configured to assess the repair costs for the dwelling based on the images of the dwelling pre- and post-event. In some embodiments, the monitoring software and/or machine-learning model is configured is also configured to evaluate pre-established cost per square foot to repair or replace.

Following the automated assessment of repair costs, the insurance company can determine the payout to the insured. In some embodiments, where a parametric insurance model is used, the payout to the insured includes a specific amount determined by what the digital images show and what the software has determined based on those digital images. For example, the payout may be a percentage of replacement cost, based on the digital images, and the pre-established criteria from the parametric insurance policy. Accordingly, in some embodiments, the combination of the replacement costs generated by the system, and the formula of parametric cost per square ft to repair, allows for an immediate calculation of insurance loss.

The machine-learning model according to any of the embodiments disclosed herein includes any suitable machine-learning model, such as, but not limited to, an unsupervised machine-learning model, a supervised machine-learning model, a deep learning model, a large language model (LLM), or a convolutional neural network (CNN). In some embodiments, the machine learning model is trained on a training set including damage photographs and corresponding repair costs. In some embodiments, the training set also includes tenant data, property data, and/or claim history for the tenant, property, and/or region. Such data includes, but is not limited to, tenant occupancy, average dwelling conditions, work orders, any other relevant information compliant with fair housing laws, and/or combinations thereof. In some embodiments, the machine-learning model independently updates average material and/or labor costs based upon prevailing rates.

In some embodiments, the server and/or monitoring software is configured to generate one or more user interfaces at a remote compute device 109. For example, in some embodiments, the server and/or monitoring software is configured to generate at least one of a property owner interface, a property manager interface, and/or a tenant interface. As will be understood by those skilled in the art, each user interface can have unique login credentials such that only authorized individuals can access each interface. For example, in some embodiments, only a property owner can access the property owner interface, only a property manager can access the property manager interface, and only a tenant can access their individual tenant interface. Alternatively, in some embodiments, certain individuals can access multiple interfaces (e.g., a property owner can access the property owner interface and the property manager interface). Accordingly, the remote compute device may be the same compute device for one or more interfaces, or may be a separate compute device for each interface (e.g., a first compute device for the property owner interface, a second compute device for the property manager interface, and a third compute device for the tenant interface). In some embodiments, at least one of the interfaces is accessible through a mobile device (e.g., the tenant interface includes a mobile application).

Each of the user interfaces displays (or otherwise provides access to) at least one of the sensor data, the measured damage, and/or the calculated payout following a triggering event. In some embodiments, one or more of the user interfaces also displays claim information for one or more dwellings, depending upon the user interface. The claim information may include open claims, settled claims, claim history, average claim metrics (e.g., number, payout, frequency, etc.), or a combination thereof. As will be understood by those skilled in the art, the user interfaces can be tailored to the individual user. For example, in some embodiments, the property owner interface displays a monitoring dashboard including the sensor data and/or the claim information for one or more dwellings owned by a property owner (e.g., individual dwellings, dwellings within a property, dwellings within multiple properties). In some embodiments, the property manager interface displays a monitoring dashboard including the sensor data and/or the claim information for dwellings managed by a property manager (e.g., a specific set of dwellings within a property, all of the dwellings within a property, dwellings in multiple properties). In some embodiments, the tenant interface displays a monitoring dashboard including the sensor data and/or the claim information specific to the dwelling(s) leased/rented by a tenant.

The monitoring software can also be configured to enable further action to be taken with respect to a triggering event and/or claim. Such action can include, but is not limited to, manually capturing sensor data before or after a triggering event, providing supporting information for a claim, disputing a claim, resolving a claim, or any other suitable action related to the sensor information and/or claim. In some embodiments, updates regarding sensor data, triggering events, and/or claims can be manually or automatically communicated to and/or between users through the monitoring software. For example, in some embodiments, the monitoring software is configured to automatically communicate updates when new sensor data is recorded, a triggering event has occurred, a claim has been opened, and/or a claim has been resolved.

Although disclosed herein primarily with respect to a property owner interface, property manager interface, and tenant interface, as will be appreciated by those skilled in the art, the disclosure is not so limited and may include any other suitable arrangement or type of user interface. For example, in some embodiments, the monitoring software is configured to generate an insurance provider interface. In some such embodiments, the insurance provider interface includes sensor data and/or claim information for multiple property owners and/or policy holders. Additionally or alternatively, in some embodiments, the insurance provider interface can enable input of relevant information for training of the machine-learning model (e.g., updated damage photos, changes in material/labor costs, changes in policy details, etc.), enabling more accurate and efficient claim resolution.

Also provided herein are methods of settling insurance claims. In some embodiments, the method includes providing the system according to any of the embodiments disclosed herein; receiving, at the computer, the sensor data from the one or more sensors prior to a triggering event; receiving, at the computer, the sensor data from the one or more sensors after a triggering event; comparing the sensor data from before and after the triggering event; and measuring a repair cost based upon the comparison. In some embodiments, the method also includes detecting the triggering event with the one or more sensors. In such embodiments, the method can further include recording sensor data at the time of, during, and/or immediately following the triggering event. In some embodiments, after measuring the repair cost, the method further includes calculating a claim payout.

In some embodiments, the method includes generating one or more user interfaces accessible through a remote compute device, each user interface configured to display or provide access to the sensor data and/or claim information specific to the user. For example, in some embodiments, the method includes generating a property owner interface configured to display claim information for each of the one or more dwellings at one or more properties owned by a property owner; generating a property manager interface configured to display claim information for each of the one or more dwellings at one or more of the properties managed by a property manager; and/or generating a tenant interface configured to display claim information specific to a tenant accessing the tenant interface. In some embodiments, one or more of the user interfaces also provide access to the sensor data for covered dwellings and/or claims. In some embodiments, the claim information includes claim status, measured damage, calculated payout, and/or claim history. In some embodiments, the method also includes generating an insurance provider interface according to any of the embodiments disclosed herein. As will be appreciated by those skilled in the art, in some embodiments, certain user interfaces will provide information not available in other user interfaces. For example, in some embodiments, the property owner and property manage interfaces display damage calculations, while the tenant interface only displays calculated payout.

Each of the user interfaces is accessible through any suitable remote compute device, such as, but not limited to, a personal computer, tablet, mobile device, and/or any other suitable compute device. The remote compute device may be the same or different for each user interface, with the different user interfaces being accessible through different applications and/or user credentials. For example, in one embodiment, each of the property owner interface, the property manager interface, and the tenant interface can be accessed through the same remote compute device using different applications and/or different user credentials. In another embodiment, the property owner interface is accessible through a first remote compute device, the property manager interface is accessible through a second remote compute device, and the tenant interface is accessible through a third remote compute device.

In some embodiments, the method includes executing a machine-learning model according to any of the embodiments disclosed herein on the sensor data. For example, in some embodiments, the machine-learning model is configured to measure damage and/or calculate payout when a triggering event is detected and/or a claim is initiated. The sensor information, measured damage, and/or calculated payout can then be displayed in the user interfaces by the monitoring software. Additionally or alternatively, in some embodiments, the machine-learning model is configured to automatically record sensor data based upon set intervals, detection of a triggering event, prediction of a triggering event, and/or any other suitable information relating to recording of sensor data.

In some embodiments, the method further includes training the machine-learning model. The training includes providing a training set according to any of the embodiments disclosed herein and training the machine-learning model to generate the one or more alerts with the training set. In some embodiments, the training set includes damage photographs and corresponding repair costs. In some embodiments, the training set also includes tenant data, property data, and/or claim history for the tenant, property, and/or region. Such data includes, but is not limited to, tenant occupancy, average dwelling conditions, work orders, any other relevant information compliant with fair housing laws, and/or combinations thereof. In some embodiments, the training includes comparing damage and cost to types of triggering events. In some embodiments, the training machine-learning model can measure damage to a dwelling, and determine the corresponding cost to repair, based upon images of the dwelling from before and after a triggering event.

Further provided herein is a non-transitory, processor-readable medium storing instructions that, when executed by a processor, cause the processor to implement the method according to any of the methods disclosed herein.

The systems and methods disclosed herein provide automated, objective measurement of dwelling damage and calculation of claim payout. As disclosed herein, the systems and methods can utilize multiple types of sensors in a residential home or group of homes, as well as a multi-family residential property which will often include many separate buildings, and compare sensor data from many IoT devices with other data sources to detect triggering events, measure damage, and calculate payout as needed.

Although the invention has been described in terms of exemplary embodiments, it is not limited thereto. For example, although described herein primarily with respect to monitoring of multi-unit dwellings, as will be appreciated by those skilled in the art, the disclosure is not so limited and may be used to monitor any other suite of internet of things (IoT) connected devices. Accordingly, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

The following examples further illustrate aspects of the present invention. However, they are in no way a limitation of the teachings or disclosure of the present invention as set forth herein.

### EXAMPLES

### Example 1

FIG. 1 shows a block diagram illustrating an exemplary system 100 according to one or more of the embodiments disclosed herein. The one or more sensors 101 are coupled to the computer 103, which includes a processor 102, a memory 104, and I/O interface(s) 108 that communicate with each other, and with other components, via a bus 120. The bus 120 can include any of several types of bus structures including, but not limited to, a memory bus, a memory controller, a peripheral bus, a local bus, and any combinations thereof, using any of a variety of bus architectures. The computer 103 can be or include, for example, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. The computer 103 can also include multiple compute devices that can be used to implement a specially configured set of instructions for causing one or more of the compute devices to perform any one or more of the aspects and/or methodologies described herein.

The computer 103 can include a network interface 106 that can be utilized for connecting the computer 103 to one or more of a variety of networks 140 (e.g., network) and one or more remote devices 109 connected thereto. In other words, various devices, including the computer 103, can communicate with other devices, including the remote compute device 109, via the network 140. The network 140 can include, for example, private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network 140 can be a wireless network such as, for example, a Wi-Fi or wireless local area network (“WLAN”), a wireless wide area network (“WWAN”), and/or a cellular network. In other instances, the network 140 can be a wired network such as, for example, an Ethernet network, a digital subscription line (“DSL”) network, a broadband network, and/or a fiber-optic network. In some instances, the computer 103 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 140 can be encrypted or unencrypted. In some instances, the network 140 can include multiple networks or subnetworks operatively coupled to one another by, for example, network bridges, routers, switches, gateways and/or the like.

The processor 102 can be or include, for example, a hardware based integrated circuit (IC), or any other suitable processing device configured to run and/or execute a set of instructions or code. For example, the processor 102 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 102 can be configured to run any of the methods and/or portions of methods discussed herein.

The memory 104 can be or include, for example, a random-access memory (RAM), a memory buffer, a hard drive, a read-only memory (ROM), an erasable programmable read-only memory (EPROM), and/or the like. In some instances, the memory 104 can store, for example, one or more software programs and/or code that can include instructions to cause the processor to perform one or more processes, functions, and/or the like. In some implementations, the memory 104 stores software 105, such as the monitoring software and/or machine-learning model disclosed herein. In some implementations, the memory 104 includes software configured to generate a damage measurement 126 and/or a user interface 122 accessible through the remote compute device 109. In some implementations, the memory 104 can include extendable storage units that can be added and used incrementally. In some implementations, the memory 104 can be a portable memory (e.g., a flash drive, a portable hard disk, and/or the like) that can be operatively coupled to the processor 102. In some instances, the memory 104 can be operatively coupled with another device, such as, for example, a database 107. In such implementations, the database 107 can serve as additional storage for data such as, but not limited to, sensor data 110, user data 112, external data 114, and/or training data 116. The memory 104 can include various components (e.g., machine-readable media) including, but not limited to, a random-access memory component, a read only component, and any combinations thereof.

In one example, a basic input/output system (BIOS), including basic routines that help to transfer information between components within the computer 103 can be stored in memory 104. The memory 104 can further include any number of program modules including, for example, an operating system, one or more application programs, other program modules, program data, and any combinations thereof.

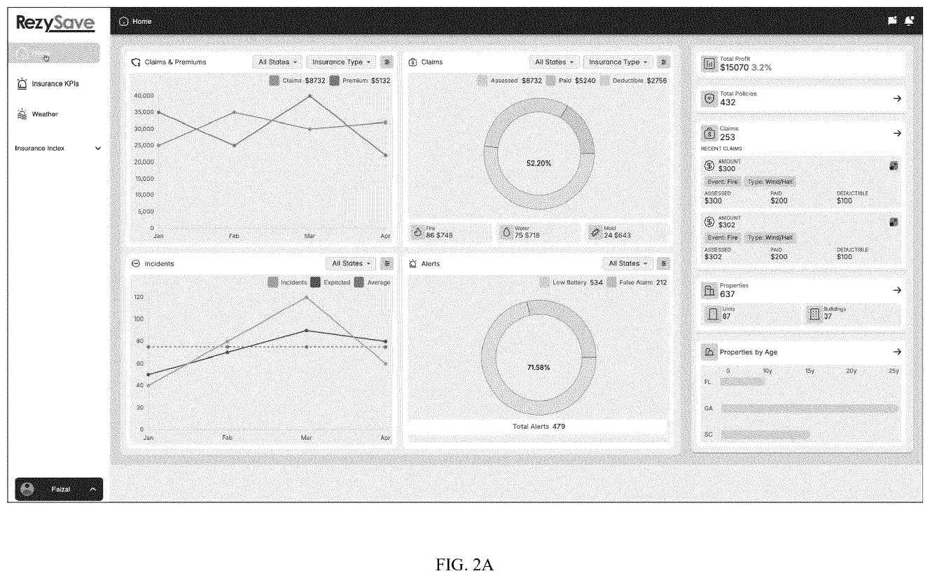

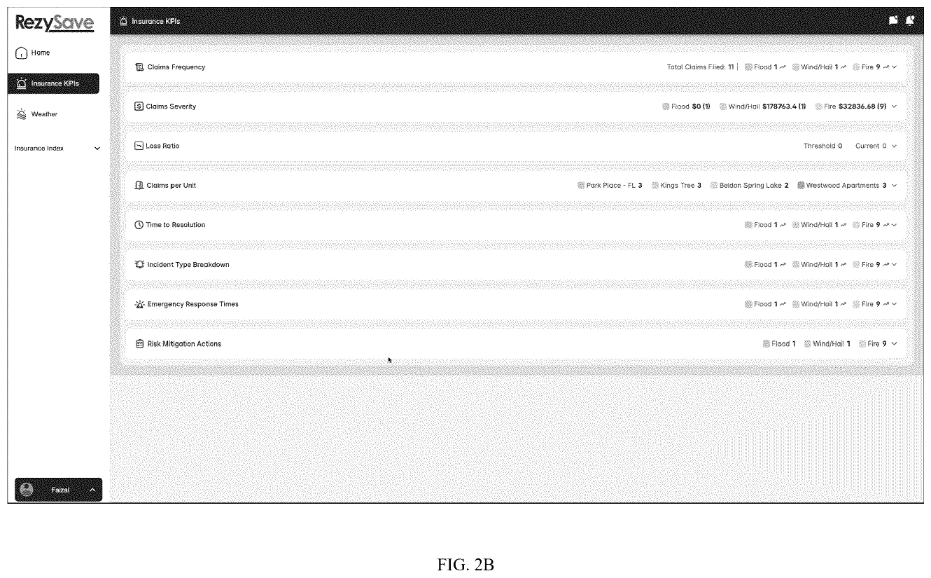

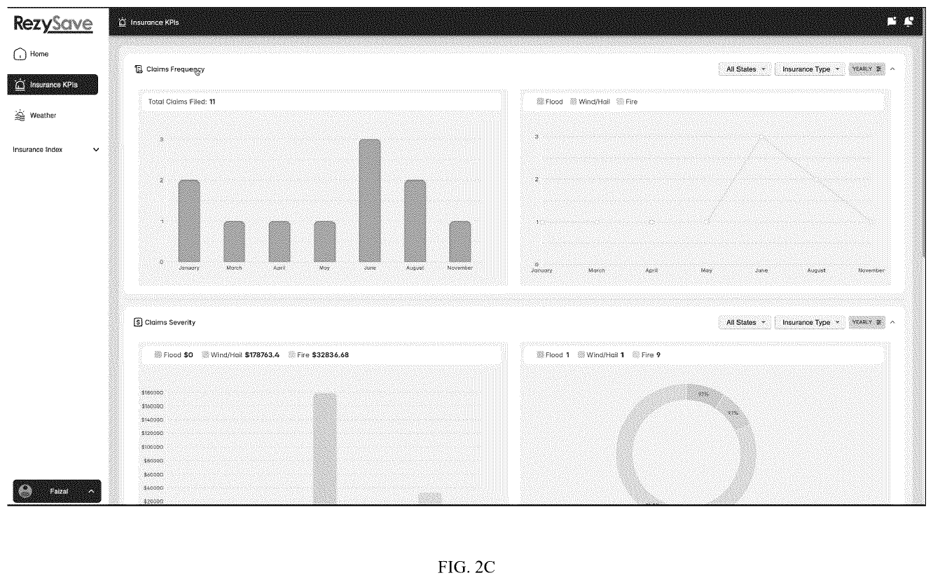

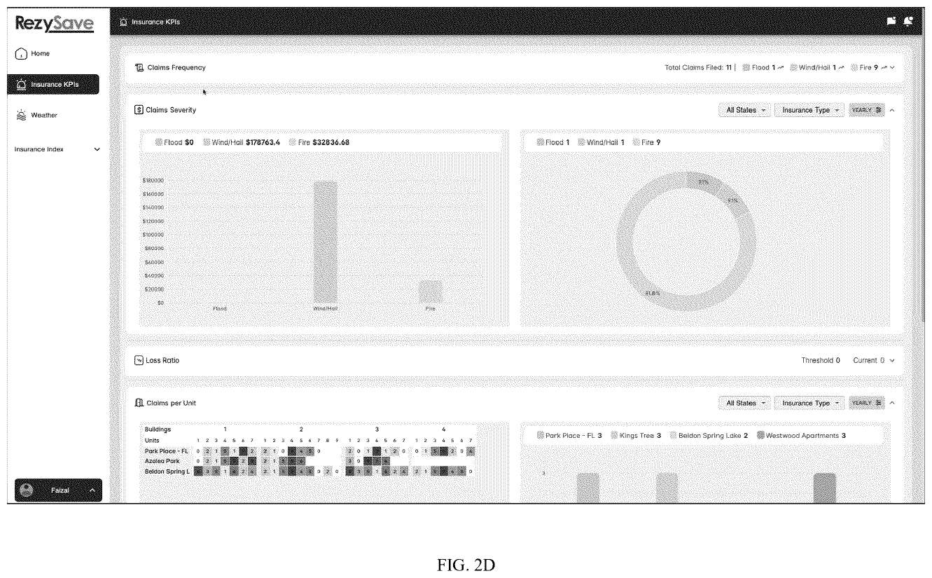

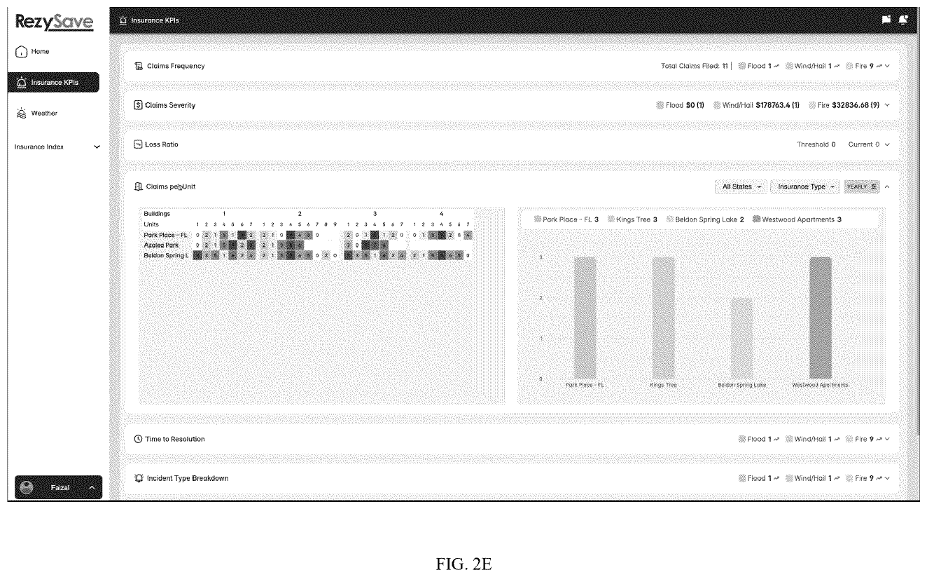

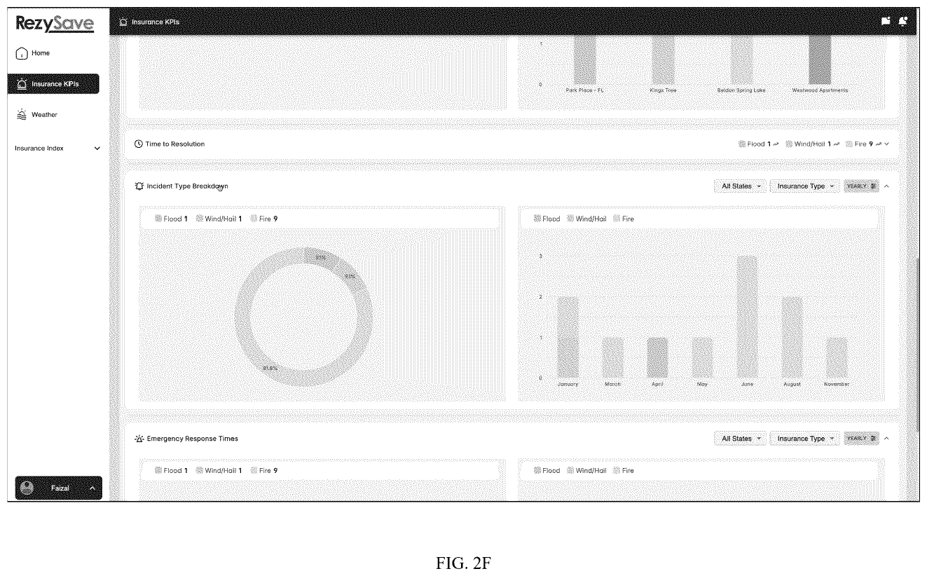

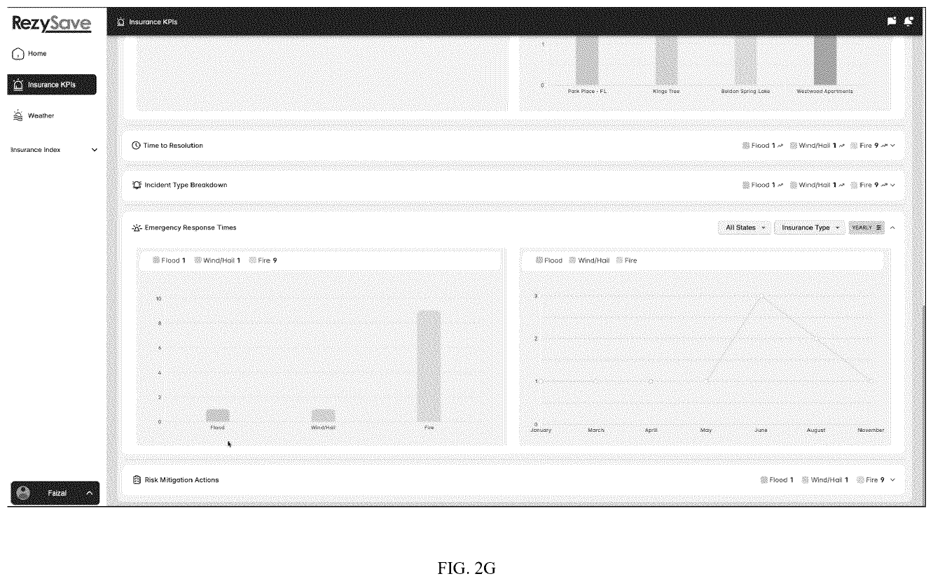

FIGS. 2A-G show screenshots of various aspects of the monitoring software and user interface. As shown therein, claim information can be displayed from individual dwellings as well as from one or more properties including multiple dwellings.

### EQUIVALENTS

Although preferred embodiments of the invention have been described using specific terms, such description is for illustrative purposes only, and it is to be understood that changes and variations may be made without departing from the spirit or scope of the following claims.

What is claimed is:

1. A system for settling insurance claims, the system comprising:
a computer;
one or more remote sensors configured to:
generate sensor data for at least one dwelling; and
communicate the sensor data to the computer; and
monitoring software configured to run on the server;
wherein the sensor data includes:
a first set of sensor data collected at a first time point; and
a second set of sensor data collected at a second time point; and
wherein the monitoring software is configured to:
process the sensor data;
compare the first set of sensor data to the second set of sensor data; and
measure damage to the at least one dwelling based upon the comparison of the first set of sensor data to the second set of sensor data.

2. The system of claim 1, wherein:
the first time point is before a triggering event; and
the second time point is after the triggering event.

3. The system of claim 2, wherein:
the first set of sensor data includes images of the dwelling before the triggering event; and
the second set of sensor data includes images of the dwelling after the triggering event.

4. The system of claim 3, wherein the one or more remote sensors include a digital camera.

5. The system of claim 3, further comprising:
a machine-learning model configured to run on the computer;
wherein the machine-learning model is configured to automatically measure the damage to the dwelling caused by the triggering event.

6. The system of claim 5, wherein the machine-learning model is an unsupervised machine-learning model, a supervised machine-learning model, a deep learning model, or a convolutional neural network (CNN).

7. The system of claim 5, wherein the machine-learning model is configured to detect the triggering event based upon the sensor data.

8. The system of claim 7, wherein the machine-learning model is configured to automatically record the second set of sensor data after the triggering event.

9. The system of claim 7, wherein the machine-learning model is configured to automatically record images of the dwelling during the triggering event.

10. The system of claim 7, wherein the one or more remote sensors include a digital camera and at least one of a water flow sensor, a water leak sensor, a temperature sensor, a motion sensor, a license plate recognition sensor, a smoke detector, a carbon monoxide sensor, a thermal imaging sensor, a barometric sensor, a power line sensor, a current sensor, and combinations thereof.

11. The system of claim 10, wherein the one or more sensors are connected through the internet of things (IoT).

12. The system of claim 5, wherein the machine-learning model is trained on a training set including at least one of damage photographs and corresponding repair costs, tenant data, property data, claim history for a tenant, property, and combinations thereof.

13. The system of claim 1, wherein the monitoring software is further configured to generate at least one user interface.

14. The system of claim 13, wherein one or more of the at least one user interfaces is configured to display claim information for the at least one dwelling following the triggering event.

15. A method of settling insurance claims, the method comprising:
providing the system according to claim 3;
receiving, at the server:
the first set of sensor data; and
the second set of sensor data;
comparing, via the monitoring software, the first set of sensor data to the second set of sensor data;
measuring, via the monitoring software, damage to the at least one dwelling based upon the comparison of the first set of sensor data to the second set of sensor data; and
calculating a claim payout based upon the measured damage.

16. The method of claim 15, wherein the monitoring software comprises a machine-learning model.

17. The method of claim 16, further comprising training the machine-learning model, the training including:
providing a training set including at least one of damage photographs and corresponding repair costs, tenant data, property data, claim history for a tenant, property, and combinations thereof; and
training the machine-learning model on the training set.

18. The method of claim 15, wherein the insurance claim comprises a parametric insurance claim.

19. The method of claim 15, further comprising generating at least one user interface.

20. A non-transitory, processor-readable medium storing instructions that, when executed by a processor, cause the processor to implement the method according to claim 15.
